(19) United States
(12) Patent Application Publication
(10) Pub. No.: US 2003/0195043 A1
(43) Pub. Date: Oct. 16, 2003

(54) System and method for live interactive remote gaming using casino-based proxies

(75) Inventors: Craig Edward Shinners, Pasadena, CA (US); Son Thanh Vuong, Vancouver (CA); Binh Thanh Vuong, Simi Valley, CA (US); Vinh Thanh Vuong, Simi Valley, CA (US)

Correspondence Address: CRAIG E. SHINNERS, LAW OFFICE OF CRAIG E. SHINNERS, 301 E. COLORADO BLVD, SUITE 610, PASADENA, CA, 91101, US

(73) Assignee: VT TECH CORP., Simi Valley, CA

(21) Appl. No.: 10/121,621

(22) Filed: Apr. 11, 2002

(51) Int. Cl. G06F 17/00

(52) U.S. Cl. 463/42

(57) ABSTRACT

The present invention relates to a gaming system and method for enabling remote players to participate in the play of a casino game of chance through a selected proxy. The gaming system enables remote interactive gaming by a large number of remote players who place wagers with the outcome determined by the play of the proxy. The proxy is equipped with a personalized transmitter module so that audio signals spoken by the proxy and the ambiance of the casino are transmitted to remote players. The presence of the transmitter module is detectable by a gaming machine. Each gaming machine includes a machine manager and at least two video cameras. One video camera is internal to the game machine cabinet but positioned to capture the video image of the physical player. The other camera is positioned such that it is able to capture the result of the game of chance. Machine manager detects the result and transmits this information to a network manager for use in calculating payouts for winning wagers.

### BACKGROUND OF THE INVENTION

(1) Field of the Invention

The present invention relates to a system and method for playing casino games and more specifically to a system and method that enables remote players to select a proxy player and remotely place independent bets in a game of chance being played in a casino.

(2)

Playing games of chance over the Internet is a popular past time for many people. Indeed, it is widely believed that more than 1,200 “on-line” casinos attract a large number of players who are otherwise unable to travel to a physical casino and play their desired game of chance in person. In this Internet embodiment, the casino is little more than a computer server connected to the World Wide Web or other communication network. The computer server acts as a gateway to one or more computers that execute computer software replicating the games of chance. For example, the computer software could replicate the game of roulette, baccarat, craps, blackjack or pai gow (an Asian poker game) depending on the game of chance a player desires to play. Thus, when the player accesses the computer server, their request to play a particular game is directed to the requested software.

While a software generated game of chance may closely replicate the odds of winning, many players would prefer to play at an actual casino where there is a real deck of cards or pair of die. For this reason, a real-time interactive gaming system (RIGS) was described in U.S. Pat. No. 5,762,552, assigned to VT TECH Corp., the assignee of the present invention. The RIGS provides a system that permits remote players to participate in either live action or software generated games of chance. However, it is difficult for many remote players to participate in live action games in real time because of bandwidth limitations or because of transmission delay. In other circumstances, it is difficult to capture the excitement of winning because the remote player is, in fact, remote from the action on the floor.

What is needed is a system and method that permits a large number of remote players to participate in the play of a game of chance initiated by a player physically present at the casino while at the same time conveying the sense of excitement and entertainment provided attendance at a land-based casino.

### SUMMARY OF THE INVENTION

The present invention relates to a system and method for enabling remote players to participate in the play of casino games through a selected proxy. As used herein, a proxy is a player who is physically present at the casino (that is, a “physical player”) and playing the selected game of chance. The physical player may be a celebrity entertainer, a high roller, a participant in a gaming tournament or just a “person off the street.” In accordance with the present invention, a computer-based system for enabling remote interactive gaming is improved by including a “smart” gaming machine configured to enable large number of remote players to participate along with the physical player playing at the gaming machine.

Upon entering the casino's computer based interactive game system, each remote player selects a physical player from a list of available players. The selected physical player then serves as a proxy for that remote player during play of a game of chance. It should be understood that each physical player may act as a proxy for none, one or many remote players.

The physical player, also referred to as the “proxy”, is equipped with a personalized transmitter module to transmit audio signals spoken by the proxy and the ambiance of the casino to remote players. In some embodiments, the physical player may engage an optional speaker so as to hear comments by one or more remote players in a manner similar to an old-fashioned party line environment. In this manner, the proxy may solicit comments from remote players so that play can proceed based on a “majority vote” by the remote players.

In one preferred embodiment, the gaming machine is a slot machine of a type well known in the field of casino games. The game machine includes a machine manager and at least two video cameras. One video camera is internal to the game machine cabinet but positioned to capture the video image of the physical player. The other camera is positioned such that it is able to capture the result displayed by the game machine, or if detection is automatic, the ambiance of the casino environment. Machine manager detects the result and transmits this information to a network manager for use in calculating payouts for winning wagers placed by remote players. Thus, remote players are provided the opportunity to view the actual play of the game of chance at the gaming machine while the network manager determines if a wager is won or lost. Play by the proxy is unaffected by the play of the remote players.

In another embodiment, the gaming machine is a seat at a live action table game with a table manager providing control functions. Examples of a live action table game are casino games based on cards (blackjack, pai gow, baccarat, etc), die (craps) or wheels (roulette). Cameras are positioned to capture the proxy, the dealer or other casino employees and players and each play of the game of chance. The proxy plays at the table game as if they are playing for their own account, but as is the case where the gaming machine is a slot machine, a plurality of remote players may place their bets that are determined based on the outcome achieved by the proxy. Automatic detection of the gaming object (the cards dealt to the proxy, the value of the dice, etc.) is critical to ensure prompt and correct of settlement of wagers placed by remote players upon completion of each play of the game of chance.

In operation, the manager detects the presence of a proxy playing the game of chance. The proxy is equipped with a portable transmitter module that includes a contactless proximity device or identifying indicia that identifies the player as a proxy. By way of example, contactless proximity devices include radio frequency identification (RFID) circuits and Bi-Statix identification circuits. BiStatix technology is available from Motorola Inc.

The transmitter module notifies machine manager that a proxy is playing. Second, the transmitter module includes a microphone (and optionally a camera) so that the proxy is able to transmit audible sounds of both the physical player as well as the ambient noise of the casino. Optionally, the camera transmits visual images from the casino to remote players. Each transmitter module is uniquely identified so that each proxy may be located and tracked by the network manager. In this manner, remote players can select from a plurality of physical players with whom they will participate with while playing the selected game of chance. The system and method of the present invention is more clearly described in the following detailed description of a preferred embodiment.

### DESCRIPTION OF THE DRAWINGS

FIG. 1 shows a block diagram of one embodiment of an exemplary computer-based system for practicing the invention.

FIG. 2 illustrates a top view of a gaming table in accordance with the present invention.

FIG. 3 illustrates an exemplary flow diagram of operation of one embodiment of an exemplary computer-based system for practicing the invention, specifically, the registration of a proxy.

FIG. 4 further illustrates an exemplary flow diagram of operation of one embodiment of an exemplary computer-based system for practicing the invention, specifically, the selection of a proxy and play of a game of chance by remote players and the proxy.

FIG. 5 illustrates a “play profile” that may be configured by remote players for automatic play.

FIG. 6 shows a top view of a table game for the play of a casino game of chance involving cards or dice.

FIG. 7 shows an embodiment of a game console for use by a remote player when playing a game of change by way of a proxy.

FIG. 8 shows an alternative embodiment of the game console.

### DETAILED DESCRIPTION OF A PREFERRED EMBODIMENT

The present invention relates to a system for enabling remote play of a live action game of chance. More particularly, the present invention relates to an improved gaming system that enables remote play by an unlimited number of remote players. The players may participate in a live action game of chance or play a traditional slot game. In the following description of the preferred embodiment, reference is made to the accompanying drawings that form a part hereof, and in which is shown by way of illustration a specific embodiment in which the invention may be practiced. It is to be understood that other embodiments may be utilized and that changes may be made without departing from the scope of the present invention.

Reference will now be made in detail to the preferred embodiments of the invention, examples of which are illustrated in the accompanying drawings. Wherever possible, the same reference numbers will be used throughout in the drawings to refer to the same or like components.

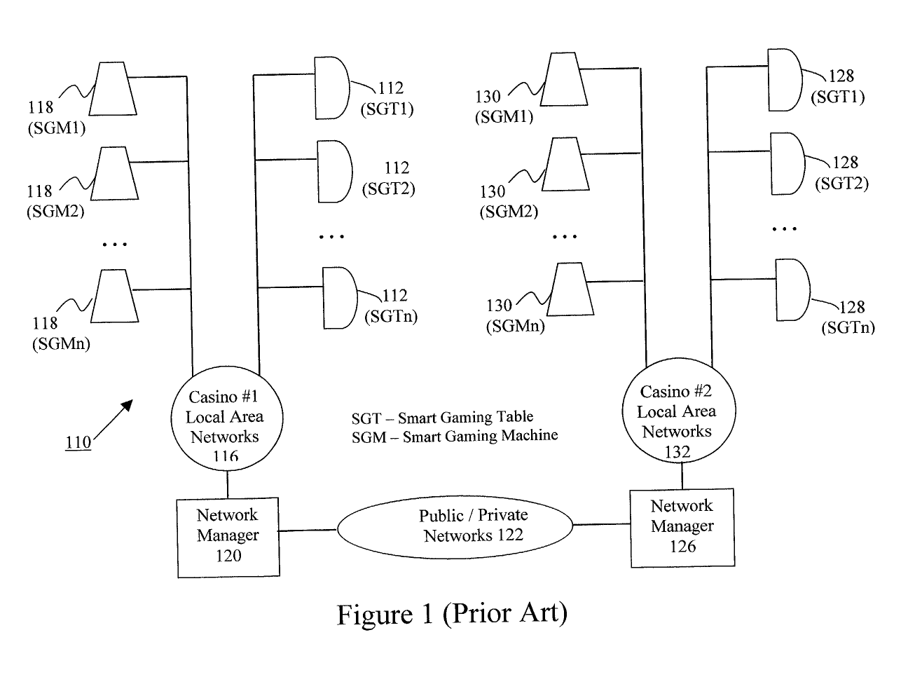

FIG. 1 illustrates the hardware components of an exemplary computer-based system 110 for practicing the invention. Specifically, the present invention comprises a plurality of smart gaming tables 112 at a first casino 114. At each table, a sequence of plays of a particular game of chance is conducted. Each table 112 is connected to a local area network 116. A plurality of gaming machines 118 is also connected to network 116. By selecting one of said plurality of tables 112, a remote player (not shown) positioned at one of the gaming machines 118 can participate in the play of the game of chance conducted at the selected table.

Casino 114 also includes a network manager 120, which is connected to network 116. Network manager 120 acts as a portal to a public or private network 122, which may be a telephone, satellite or Internet network or other worldwide communication network. Also coupled to network 122 is a second casino 124 via network manager 126. Casino 124 is essentially a mirror image of casino 114 in that it comprises a plurality of gaming tables 128 and gaming machines 130 each and which are coupled by a local area network 132 to network manager 126. Gaming machines 130 are identical to gaming machines 118 except that they are located at a site remote from casino 114. Similarly, gaming tables 128 are identical to gaming tables 112 except that they are also located at a different site.

One advantage of the configuration illustrated in FIG. 1 is that a player at one of the gaming machines 118 can play a game of chance being conducted in a different casino at one of the gaming tables 128. Thus, a player at a casino situated in one part of the country could play the tables at an associated casino in another part of the country or in another part of the world. This configuration of linked casinos for enabling remote play is disclosed in U.S. Pat. No. 5,762,552 which issued Jun. 9, 1998, assigned to VT TECH Corp. the assignee of the present invention, the disclosure of which is incorporated herein for all purposes.

In accordance with the present invention, the computer-based system 110 is improved by including “enhanced” gaming machines configured to enable large number of player to participate with a player physically present at a selected one of the gaming machines 118 or at the gaming table. Each remote player selects a physical player who may serve as a proxy player for one or more remote players.

The physical player is equipped with a personalized transmitter module so that audio signals spoken by the person and the ambiance of the casino are transmitted to the remote players. In an alternative embodiment, the physical player may engage an optional speaker to hear comments by one or more remote players in a manner similar to an old-fashioned party line environment. If one or more remote players become verbally abusive, the physical player may selectively disable selected one or all of the remote players. However, the audio sounds from the casino are always transmitted to the remote players.

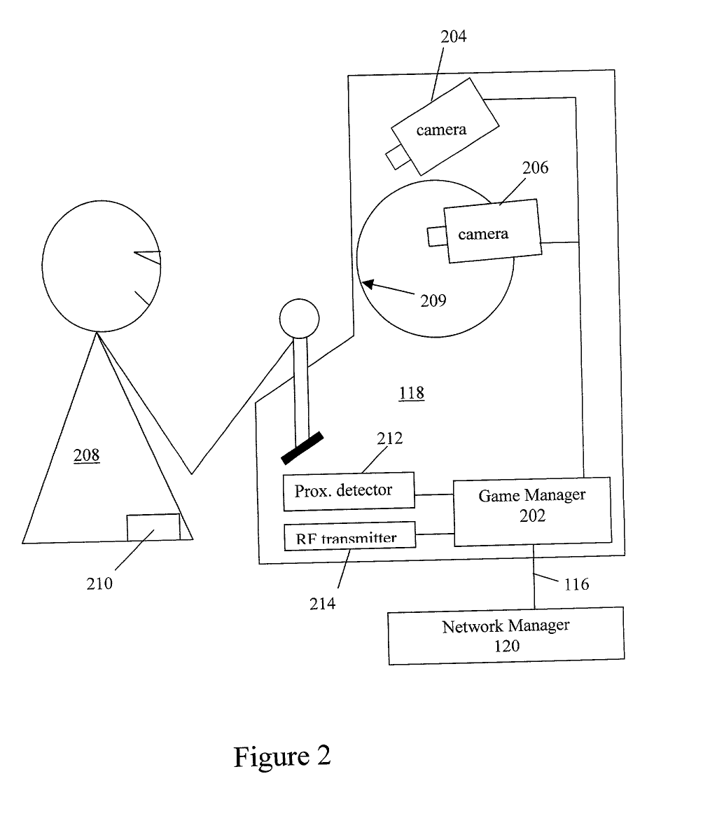

FIG. 2 illustrates one preferred embodiment of a typical game machine 118, which for purposes of illustration is a video slot machine of a type well known in the field of casino games. In this embodiment, the game machine includes a game manager 202 and at least a pair of video cameras 204 and 206. One video camera 204 is internal to the game machine cabinet and positioned to capture the video image of the physical player 208. Camera 206 is positioned such that it is able to capture the result of each play of the game of chance at the game machine from the perspective of the physical player. Specifically, for a slot machine, the results are determined by the alignment of symbols on each of a plurality of spinning reels 209. Game manager 202 also detects the result and transmits it over network 116 to network manager 120 for use in calculating payouts to winning wagers placed by remote players. Thus, remote players are provided the opportunity to view the actual play of the game of chance at gaming machine 118 by watching the transmission of the video images while the network manager 120 receives the actual result determination from the game manager 202 to quickly determine how to settle the wagers placed by remote players.

Game manager 202 is also responsible for detecting the presence of a physical player who has agreed to be a proxy and who is playing the game of chance. As used herein a proxy or proxy player is a physical player equipped with a portable transmitter module 210. Module 210 serves two functions. First, it includes a RFID proximity device that notifies game manager 202 that a proxy player is playing. Second, module 210 includes an optional microphone to transmit audible sounds of the physical player as well as the background ambiance of the casino, including the deposit of coin into a receptacle whenever the physical player wins. Module 210 may optionally include an earpiece such that the physical player may hear comments by remote players. Audio information is preferably transferred between module 210 and gaming machine 118 by means of a short-range wireless communication connection. This connection is based on either radio or cell phone technology, the only limitation is that the range of the connection be controlled so that there is limited cross talk between adjacent or proximate gaming machines 118. Since each module 210 includes a proximity device, each player may be uniquely identified and this identification information is used to encode radio transmissions between game machines 118 and module 210 so that unwanted interfering transmissions may be rejected. Manager 202 preferably includes a proximity detector 212 to detect the presence of module 210 and an RF transceiver 214 to establish and maintain a communication connection with RF transmitter of module 210.

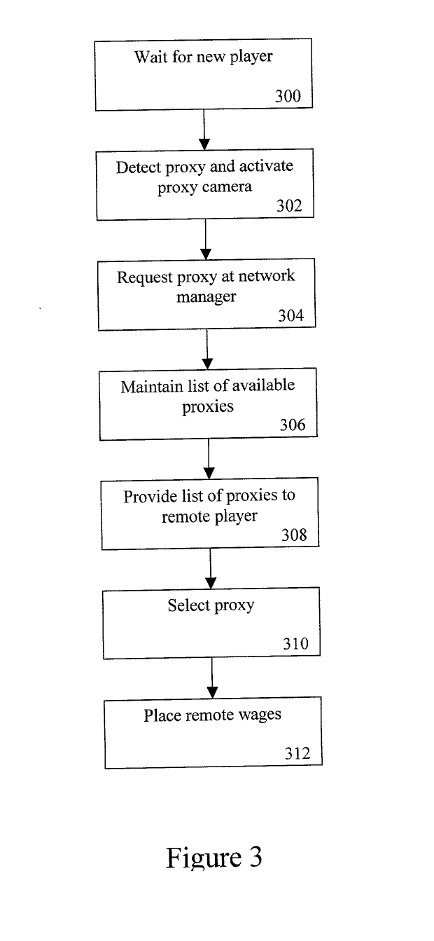

Referring now to FIG. 3 in conjunction with FIGS. 1 and 2, a representative process for implementing proxy play is illustrated. Initially, gaming machine 118 will be inactive while waiting for a player to begin play as indicated at step 300. When game manager 202 detects the presence of module 210, video cameras 204 and 206 are activated to capture the image of the physical player 208 as indicated at step 302. Game manager 202 transfers the video image to network manager 120 via the local area network 116 (see FIG. 1), step 304, and registers the physical player as an available proxy. Transferred information may include identifying information regarding the physical player. Network manager maintains a list of information relating to all active physical players in step 306. This information includes, the video image provided by video camera 204, a moniker adopted by the physical player, the type of gaming machine 118 where the physical player is playing and, optionally, a historical summary of the physical player's playing results. In step 308, network manager presents the list of available proxy players and their current gaming machines to each remote player requesting a proxy player. In step 310, remote players select their proxy and, in step 312, begin placing wagers on the play of the proxy.

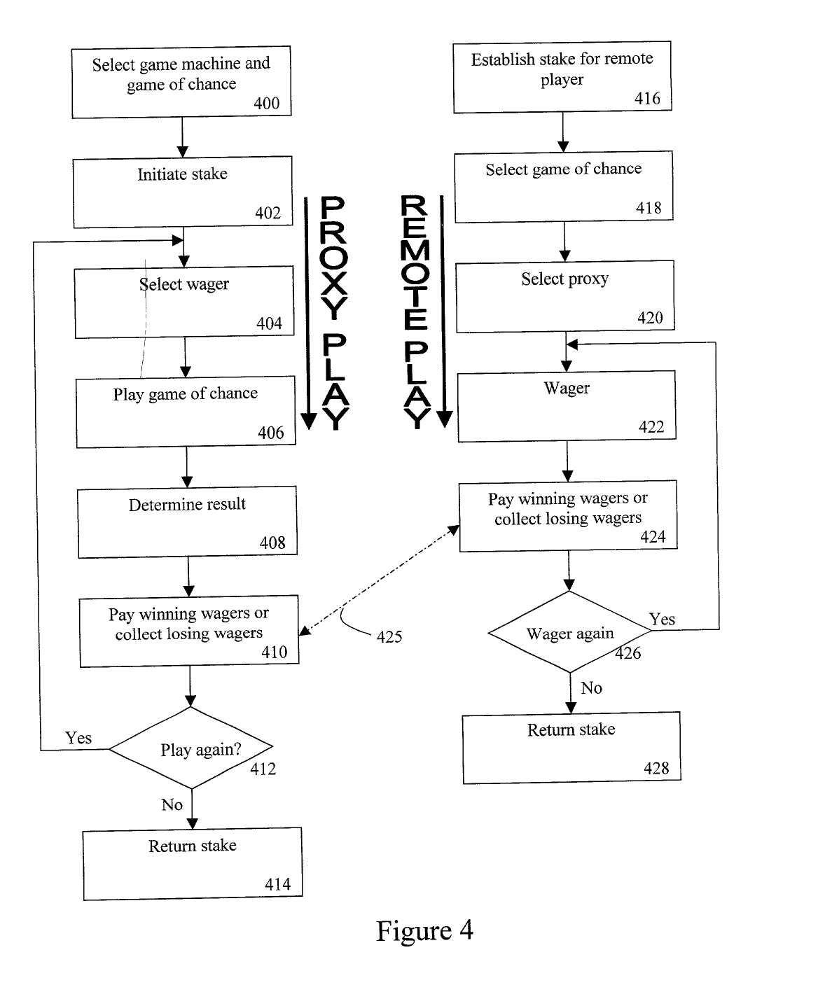

Referring now to FIG. 4, a method for enabling a remote player to participate in a game of chance played by a proxy is illustrated. The method begins when the physical player, who has agreed to be a proxy player, begins to play a game of chance on a gaming machine 118, such as a slot machine, as indicated at step 400. The proxy proceeds to play the game in its normal manner. Specifically, to start play, the proxy establishes a stake with the gaming machine as indicated at step 402. The stake may be established by depositing cash or by accessing a pre-established credit account maintained by the casino. Thereafter, the proxy initiates play by selecting the amount of wager as indicated at step 404. The proxy then activates the gaming machine in step 406 by either pressing a button or pulling on the activation lever in a manner that is well known. Once activated, the gaming machine will perform certain functions such as emitting sounds and blinking lights until an outcome is displayed to the physical player as indicated at step 408. The network manager transmits video and casino ambience to one or more remote players. If the physical player is a winner, as indicated in step 410, the winnings are paid by ejecting a plurality of coins into a metal bin thereby generating the distinctive sound of a slot machine paying off. If the physical player does not win, the wagered amount is lost. Play by physical player continues with action looping back to step 404 until such time as the physical player decides to end the game, as indicated at step 412, and cash out their stake as indicated at step 414.

Independent of the play of the physical player, one or more remote players may access casino 114 over the public or private network 122 and initiate a stake as indicated at step 416. It will be understood that the remote player has virtual access to each of a plurality of casinos coupled to network 122 with each casino offering a unique slate of physical players as proxy players. The only requirement for the remote player is that they have access to a gaming machine, such as gaming machine 130 at one of the casinos, such as casino 2, coupled to the network 122 (see, FIG. 1) or at another controlled environment such as a kiosk at a coffee shop, by way of example. Alternatively, the remote player may use a personal computer coupled to the Internet or to a virtual private network as their gaming machine. In other alternative embodiments, the player may use a cell phone or other web enabled devices coupled to a communication network to establish an audio/visual connection with the remote casino.

Once the remote player has established a stake, the remote player then selects a type of game as indicated at step 418. Available games may include table games such as craps, black jack, poker, baccarat or any of the variations thereon. Alternatively, the games may include the wide variety of slot machines that are typically offered by a modern casino. As used herein, slot machines include both electronic (video) as well as mechanical machines. Further, a slot machine may display the traditional three reels that rotate to display various symbols that determine whether the play results in a win (when the symbols are properly aligned) or a loss. In other embodiments, the slot machine may comprise a video display that may display a wide variety of games of chance. One popular type game often played on video slot machines is video poker.

Once a particular type of game is selected, the remote player then selects one of the available physical players as the proxy as indicated at step 420. In an alternative embodiment, steps 418 and 420 may be executed in reverse order. Thereafter, the physical player determines the rate of play. Each remote player need only specify a wager amount prior to the initiation of the next to occur play by the physical player as indicated at step 422. If the physical player wins (step 410), all remote players who placed a bet will be individually credited their winnings. If, however, the physical player does not win, all remote players will lose their wagered bet as indicated at step 424. Dashed line 425 shows the linkage between the results achieved by the proxy and the remote players. Following each play, the remote player may continue play by electing to play again (step 426). This election may be as simple as placing another wager with action returning to step 422.

Network manager 120, if the remote player is playing at casino 1, is responsible for payment and collection of losing wager amounts. When the remote player ends the playing session, network manager 120 will return the remote player's stake as indicated at step 428 by either crediting the player's account maintained by the casino or by crediting the stake to the player's credit card.

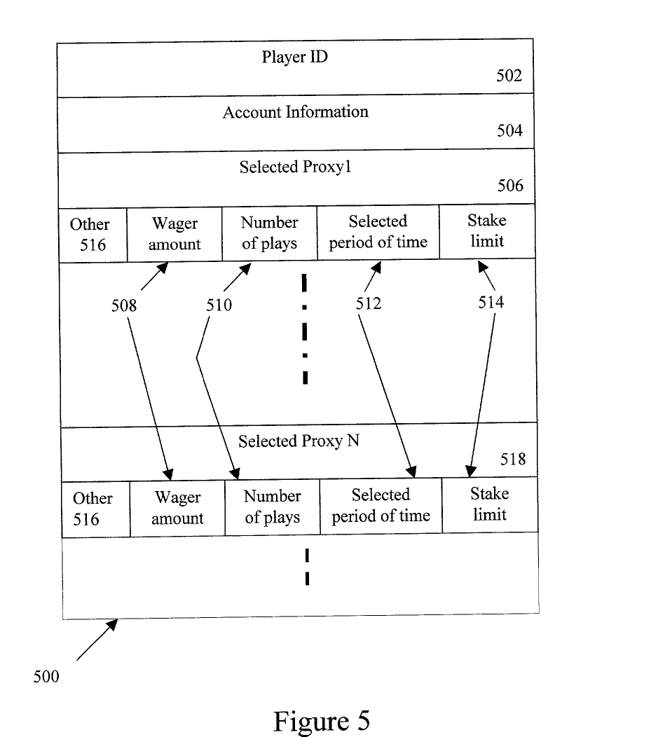

Advantageously, with the present invention, the remote player may configure a “play profile” as illustrated in FIG. 5. A play profile 500 enables the remote player to select a specific wager amount and authorize the network manager to submit a sequence of wagers based on the play of the selected proxy player. Each profile is unique to a specific player and includes a Player ID field 502 that includes information relating to the individual player such as name, location, playing history, previous visits to the casino. Each remote player links the play profile 500 to their stake by entering information into an account information field 504. Each remote player then selects a first proxy by entering proxy identifying information in proxy1 field 506. Each remote player may customize the wager pattern by selecting a constant wager amount in field 508, a set number of plays in field 510, limit play to a selected period of time in field 512 or limit change in the stake value to a selected percentage (e.g.,±10%) in field 514. The play profile 500 may also include other information that is game specific in field 516. Using the play profile 500, each remote player may inform the network manager 120 to place a series of wagers and include limitations that may restrict the amount of play to the next ten, twenty or hundred of plays (or some other selected number of plays) by the proxy player. Remote players could set up their play profile to limit play to a selected period of time, such as for no longer than ten minutes. Alternatively, remote players could set up their play profile to limit play until such time as a specific won/loss target is reached at which time network manager 120 will no longer submit further wagers with respect to the proxy identified in field 506. As indicated in FIG. 5, the play profile may be set up for more than one proxy player by specifying a profile for each selected proxy identified in field 518. In this manner, remote players may simultaneously play different games merely by selecting multiple proxies.

It should be apparent that the present invention permits an unlimited number of players to participate in the play of a game of chance and to experience the thrill of winning at a casino. The experience is enhanced by the vocal response of the proxy player, and alternatively from other remote players, transmitted to each remote player and the sense of being part of a winning team. It should also be apparent that the amount wagered by each remote player could be independent of the amount wagered by the proxy. For example, if the physical player is wagering three dollars ($3) per play, remote players may wager any amount such as a nickel or ten ($10) dollars depending on their individual preferences or the limits specified by the casino for a particular game of chance. This advantageous feature is possible because the network manager will manage the payout and collection process for each remote player. From the casino perspective, the return on their capital investment is improved by generating an increased wager amount for each play of the game of chance. To limit exposure, the casino may balance the load of remote players playing with each proxy player. Thus, if a proxy player attracts too many remote players, the casino can remove the proxy from the list of available proxies (see, step 306 in FIG. 3).

While the embodiment illustrated in FIG. 2 describes the use of a slot machine by a proxy, it should be readily apparent to one skilled in the art that the gaming machine may be a video slot machine where the game of chance is video poker, by way of example. Computerized slots or video poker machines are ideally suited for adaptation to use with a proxy because the results of each play are readily available for transmission to network manager.

Advantageously, the present invention may be combined with the system and method described in the provisional patent application entitled CASINO MANAGEMENT SYSTEM AND METHOD FOR LIVE INTERACTIVE REMOTE AND LOCAL GAMING, filed Jun. 29, 2001 and assigned application Ser. No. 60/301,939. This application is assigned to VT TECH Corp. of Simi Valley, Calif., the assignee of the present invention, and the disclosure of this application is incorporated herein in its entirety for all purposes.

Thus, physical players who agree to be a proxy player may be credited not only for their own play but also for the play of all remote players who selected the physical player as their proxy. In this manner, players who travel to the brick and mortar land-based casino will be rewarded in a manner that could far exceed the rewards they would otherwise earn. The proxy player is especially motivated if a casino player's management system tracks the play of each proxy awarding free meals, show tickets, free room, free travel or other inducements for the player to make a return visit to the casino.

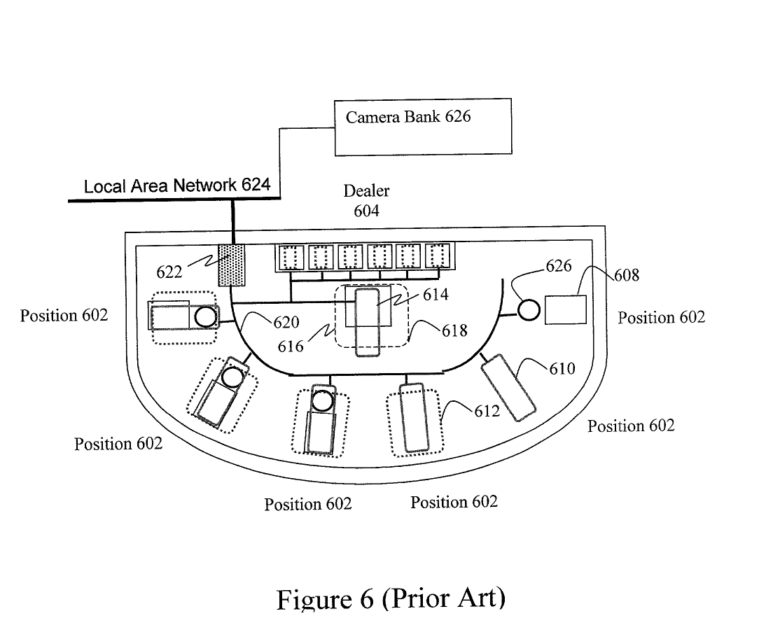

In yet another embodiment, the gaming machine is a game of chance commonly referred to as a table game such as is illustrated in FIG. 6. By way of example, table games include card games such as blackjack, poker, baccarat, carps or variations thereon.

A top view of a gaming table 600 comprises a flat playing surface covered with felt on which is typically printed a bet board for a particular game. The printed felt delineates where the cards are dealt and where the bets are positioned. Typically there are a total of six playing positions 602 if the table is used for blackjack or pai gow poker and a dealer/banker position 604. Other card games may have more or fewer playing positions or may omit the dealer's position 604. Associated with each playing position 602 is a bet slot 606 where a player may place a bet for the next to occur game of chance. Also associated is a defined position 608 where the cards are dealt.

A reader 610 is coupled to table 612 and closely proximate to at least one of the playing positions 602. In the illustrated embodiment, each playing position 602 is provided with a reader 610 although it has been eliminated from one position in FIG. 6 so as to more clearly illustrate additional features of the position 602. One skilled in the art will appreciate that each table may have any number of positions 602 and is not limited to the six positions that are illustrated.

Each reader 610 is configured to have a relatively short range as indicated by the dashed lines 612 surrounding each player position 602. Again, the range indicator has been omitted from two positions so as to more clearly illustrate the reader and other features at each position.

In this embodiment, by way of example, the proxy is seated at a playing position 602 with a camera in camera bank 626 mounted to provide a view of table 600 and a second camera in the camera bank positioned such that the image of the proxy is available. A third optional camera may provide the image of the dealer at dealer position 604.

In one preferred embodiment, cameras are digital video cameras that generate a stream of digitized video to network manager 112. When a proxy is located at a selected position within the viewing area of the digital video camera, the table manager detects the transmitter module and registers the proxy with the network manager.

Thus, the remote player may select from a variety of views, including a view of the playing surface, the proxy or the dealer. The concept of a smart table 600 is more fully described in the co-pending United States patent application entitled, SYSTEM AND METHOD FOR DETECTING THE RESULT OF A GAME OF CHANCE, Ser. No. 09/782833 filed Feb. 14, 2001, assigned to VT TECH Corp. of Simi Valley, Calif., the assignee of the present invention, the disclosure of which is incorporated herein in its entirety for all purposes. As described in this application, the cards or die (referred to as “gaming objects”) include embedded RFID circuits that are encoded with proprietary information. Thus, the value of the gaming object may be readily detected in real time during each play of the game of chance.

During play at table 600, the proxy is responsible for controlling the play of the game of chance. The proxy places his or her own bet in bet slot 606 and plays cards as they are dealt to card placing area 608. Since the value of the cards or gaming objects are detected by RF reader 610, the value may be readily transmitted to all remote players each of whom may place wagers over network 122 at network manager 120 for the next to occur play. If the proxy is successful, all remote players are also successful with all accepted wagers. However, if the proxy were to lose, all remote players will also lose their wagered amounts. In this embodiment, remote players are dependant on the skill or luck of the selected proxy. Remote players do not have any control or make any contribution to the play of the game. If a remote player places a wager that is received at the network manager after the start of the play of the game of chance, the wager is applied to the next to occur play.

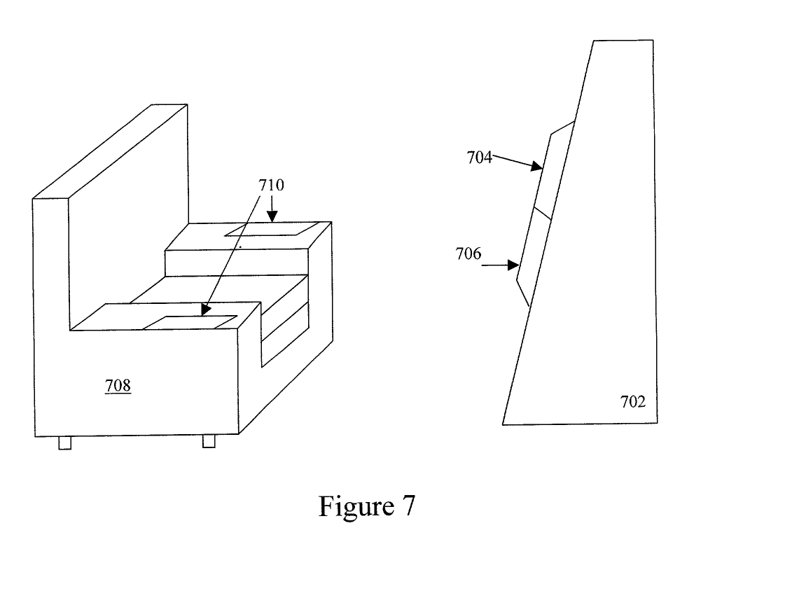

Referring now to FIG. 7, a gaming console 700 is illustrated. In this embodiment, a remote player is provided a unique visual perspective of the action at gaming machine 118 or table 600. Gaming console 700 comprises a monolithic tower enclosure 702 that provides a first display 704 and a second display 706 for a viewer positioned, by way of example, in a comfortable chair 708. Enclosure 702 is positioned a comfortable distance from chair 708 such that the remote player is afforded the opportunity to view both displays 704 and 706. When displays 704 and 706 are each flat screen displays, such as a large flat screen television display, chair 708 may be positioned from between one (1) meter to six (6) meters from enclosure 702.

Chair 708 includes at least one arm pad data entry device 710 so that the remote player may control what camera angle is displayed on one of displays 704 and 706. It will be appreciated by one skilled in the art that when playing at a remote location, the player needs to see the actual play of the game as it occurs at the gaming machine or at the table. For this reason, a first video capture device must be focused and positioned to provide a view that conveys necessary visual information. Typically this view is “top down” perspective when the gaming machine is a table game such as roulette or a “face-on” view when the gaming machine is a slot machine. Additional cameras may provide less necessary information, which while not required, will enhance the playing experience for the remote player. Thus, one or more video cameras may be positioned to provide the image of various physical players, the dealer, croupier, banker, or the proxy associated with a remote player.

The arm pad device 710 is preferably a full color LCD display that includes a touch screen panel so that the remote player may enter information thereon in response to the visually displayed information on displays 704 and 706. To minimize hearing problems, chair 708 may include speakers (not shown) or an audio connection for connecting headphones to broadcast information associated with the visually displayed information. The audio connection may be way of an RF transceiver.

Using arm pad device 710, the remote player may select to play one or more games of chance at selected casinos, select one or more proxies at each game, control the display of the images on displays 704 and 706 and enter wagers in real time or in a batch mode with wagers applied to subsequent games by network manager 112. It should be apparent that arm pad device 710 and speakers are electrically coupled to both displays 704 and 706 and to network manager 112. Although not shown in FIG. 7, chair 708 includes either a currency collection device for accepting cash wagers, a magnetic card reader for accepting credit card or other similar debit cards, and a proximity detector for interrogating contactless data cards carried by the player. The player may simply enter personal information using arm pad device 710 to enter in account information in a manner similar to using an automatic teller machine (ATM) except, instead of receiving cash, a selected amount is credited to the player's stake. When the player decides to end play, the stake is returned to a designated account.

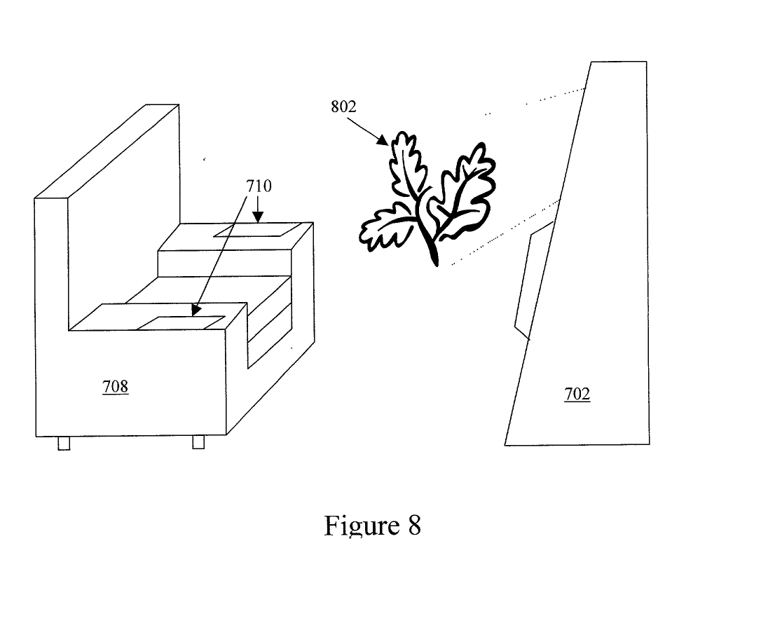

To closely replicate the visual experience of actually playing at a table 600, display 706 may be eliminated from enclosure 700 as illustrated in FIG. 8. In this embodiment, arm pad display device 710 is used to display information regarding the selected game of chance and a portion of the display is used for displaying information regarding the game of chance, such as dealt cards or the value of the dice. Another portion of the display is used to display wager information that is personal to the remote player. For example, the cards that were dealt in a table game are displayed on arm pad device 710 so that only the remote player may see the cards while at the same time the amount of the wager and the total available funds in the player's stake is also shown.

In this embodiment, enclosure 702 does not include display 704. Instead of showing other viewing perspectives on a display unit such as a LCD panel, a television or a computer monitor, the embodiment in FIG. 8 utilizes an aerial projection display that projects an image outward from enclosure 702 toward chair 708. In this embodiment, game specific information is displayed on arm pad device 710 and an image 802 which is graphically illustrated as a branch with leaves but which could be the physical player, by way of example, projected in the air between tower 702 and chair 708. In this manner, the remote player is provided game specific information in a private manner on arm pad device 710 and by looking up at aerial image, the image of one or more selected physical players or of the table. One such aerial projection display device is the HOLOVISION™ display system commercially available from Provision Interactive Technologies, Inc. of Chatsworth, Calif. In other embodiments, tower 792 may include both display 704 and the projection display to provide a three-dimensional image superimposed over or adjacent to the image displayed on display 704.

While certain exemplary preferred embodiments have been described and shown in the accompanying drawings, it is to be understood that such embodiments are merely illustrative of and not restrictive on the broad invention. Further, it is to be understood that this invention shall not be limited to the specific construction and arrangements shown and described since various modifications or changes may occur to those of ordinary skill in the art without departing from the spirit and scope of the invention as claimed.

We claim:

1. A method for playing a live game of chance at a gaming machine located within a casino by both a physical player who has agreed to play as a proxy for other players and a plurality of remote players comprising the steps of:
A) selecting a proxy at said gaming machine;
B) associating at least one remote player with said proxy;
C) initializing the play of said game of chance;
D) transmitting audio and visual signals to said at least one remote player;
E) soliciting a determination of how to play the game of chance from said proxy;
F) detecting results of the play of said game of chance;
G) based on said result, automatically paying winning wagers and collecting losing wagers from said remote players; and
H) repeating steps C-G until said proxy terminates play at said gaming machine.

2. The method of claim 1 wherein said transmitting step comprises the steps of:
transmitting information regarding the play of the game of chance to said remote player; and
displaying the transmitted information on at least a portion of a display screen of a gaming machine for viewing by said at least one remote player.

3. The method of claim 1 further comprising the step of transmitting an audio/video signal of said proxy to said at least one remote player for display on said gaming machine.

4. The method of claim I wherein said initializing step comprises the step of placing a wager by said proxy and a wager by said at least one remote player.

5. The method of claim 1 wherein initializing step further comprises the step of enabling said at least one remote player to select a sequence of wagers to be automatically placed on a series of plays of said game of chance.

6. The method of claim 4 wherein said establishing step further comprises the steps of:
Establishing a communications link between said game machine and said at least one remote player, said communications link providing a broadcast quality audio/video signal; and
Requesting said remote player to enter a bet to be applied to the next to occur play of the game of chance.

7. A method for playing a game of chance at a gaming table run by a banker, said method enabling a plurality of remote players to play from locations remote from said gaming table, said method comprising the steps of:
Establishing a proxy at said gaming table;
Associating said remote players with said proxy;
Placing a wager by said proxy;
Placing a wager by each of said remote players;
Distributing a plurality of encoded gaming objects to at least said proxy and said banker;
Detecting the value of each of said plurality of encoded gaming objects;
Transmitting, to each remote player, the value of each of said plurality of encoded gaming objects distributed to said proxy;
Requesting said proxy to determine how to play the game of chance;
Based on said determination, paying said proxy and said remote players if the play of the game of chance wins; and
Collecting the wagers from said proxy and said remote players if the play of the game of chance does not win.

8. The method of claim 7 further comprising the steps of:
comparing the value of said banker's gaming objects to the value of the gaming objects distributed to said proxy;
transmitting the value of said banker's gaming objects and the values of said proxy gaming objects to a network manager;
displaying the value of said banker's gaming objects to said remote players; and
determining the correct amount to credit or debit to each remote player in response to said comparing step.

9. The method of claim 8 further comprising the step wherein at least one of said remote players may select a sequence of wagers to be automatically placed on a series of plays of said game of chance with the outcome of each play determined by said proxy with wagers may credited or debited from said stake established by said at least one of said remote players.

10. The method of claim 7 further comprising the step of selectively displaying images associated with each play of said game of chance to said remote player.

11. The method of claim 7 wherein said associating step further comprises the steps of:
presenting a list of information describing each of a plurality of proxies; and
requesting each of said remote players to select one of said plurality of proxies.

12. The method of claim 7 further comprising the step of displaying an image of said proxy to said remote player.

13. A gaming machine system for enabling remote play of a game of chance by a physical player at a casino and a plurality of remote players, said gaming machine system comprising:
a server associated with said casino for tracking the play of said physical player and the results of each game of chance;
a housing for said gaming machine:
means for providing a game of chance and for transmitting the results of said play to said server, said providing means including a user interface to enable said physical player to initiate the play of said game of chance, said providing means located in the interior of said housing;
a display, coupled to said providing means and mounted on the housing, for displaying the play of said game of chance to said physical player;
a non-contact reader circuit, coupled to said providing means, for receiving information identifying said physical player, said information retained on an encoded device associated with said physical player, said encoded device adapted to transfer said information when proximate to said reader circuit, said reader circuit adapted to transfer said information to said providing means upon receipt, said reader circuit located in the interior of said housing;
a communications network for coupling said providing means to said server so that said information may be transferred from said gaming machine to said server; and
means, coupled to said server by said communications network, for communicating the play of each game of chance and the result of each play to said remote players.

14. The gaming machine system of claim 13 further comprising a plurality of video cameras for displaying each play of said game of chance from a plurality of perspectives for each of said remote players.

15. The gaming machine system of claim 14 wherein said housing further comprises at least one additional display, mounted on the housing, for displaying a view of said physical player for each of said remote players.

16. The gaming machine system of claim 14 wherein said housing further comprises an aerial projection display device for displaying images associated with the play of the game of chance in the air between said one of said remote players and said housing.

17. The gaming machine system of claim 13 further comprising a chair for seating one of said remote players, said chair displaced from said housing to afford a comfortable viewing of said display by said one of said remote players, said chair having user interface means, coupled to said housing, so that said remote player may place wagers and control said display and said additional display.

18. The gaming machine system of claim 17 wherein said chair further comprises a non-contact reader circuit and a user interface, said user interface having a touch sensitive display screen for initiating and controlling the play of said game of chance, said non-contact reader and said user interface coupled to said providing means.

19. A system for playing a game of chance from a remote location comprising:
a gaming table having a plurality of defined positions for playing a game of chance, at least one of which is adapted for use by a proxy;
a first video camera for generating an image of said gaming table;
a second video camera for generating an image of said proxy;
means, associated with said proxy, for detecting audible sounds generated by said proxy and by the ambient surroundings;
a network manager coupled to said gaming table for detecting the results of said game of chance, said network manager having a communication link for transfer of said images and said audible sound to said network manager; and
a gaming machine remote from said gaming table coupled to said network manager, said gaming machine adapted to selectively display the video images from said first and second video camera and for broadcasting said audible sounds upon receipt from said network manager.

20. The system of claim 19 further comprising means for detecting the presence of a proxy player at said gaming table.

21. The system of claim 19 wherein said detecting means comprises a non-contact reader circuit.

22. The system of claim 20 wherein said detecting means comprises an embedded circuit programmed with a value, said value capable of being detected by said table manager when said proxy is positioned at a playing position.

23. The system of claim 22 wherein said detecting means comprises a non-contact reader circuit.

24. The system of claim 23 wherein said non-contact reader circuit comprises a RFID circuit encoded with a value corresponding to information specific to said proxy.

25. The system of claim 24 wherein said network manager further comprises a non-contact reader for detecting the encoded information, said encoded information capable of being detected by said non-contact reader only when said proxy is positioned proximate to said gaming table.

26. In a real-time interactive gaming system having a plurality of live action gaming machines adapted for play by a plurality of remote players, where each remote player may place wagers on a selected game of chance being conducted by at least one of said gaming machines, said real-time interactive gaming system having means for transmitting broadcast quality signals of the live action play of the game of chance to each of said remote players, said real-time interactive gaming system comprising:
means for detecting the presence of a proxy playing a game of chance at said at least one of said gaming machines;
means for associating said proxy with said remote players;
detector means associated with said at least one of said gaming machines for automatically detecting the outcome of each play of the game of chance; and
a game manager, coupled to said detector means, for associating the detected values with the wagers received from said remote players.

27. The real-time interactive gaming system of claim 26 further comprising means for establishing a remote player's stake.

28. The real-time interactive gaming system of claim 26 wherein said detecting means comprises a transponder circuit, associated with said proxy, encoded with information specific to said proxy, for transferring said information to said game manager when said transponder circuit is positioned proximate to said detector means.

29. The real-time interactive gaming system of claim 28 further comprising means, coupled to said gaming machine, for automatically detecting the outcome of each play of the game of chance and for transmitting the outcome to said remote players.

30. The real-time interactive gaming system of claim 29 wherein said computer system further comprising a display device for displaying the play of each game of chance for viewing by said remote player.

31. The real-time interactive gaming system of claim 30 further comprising a second display device for displaying said proxy to said remote players.

32. The real-time interactive gaming system of claim 30 wherein said display device comprises an aerial projection system.

33. A gaming machine for playing a game of chance comprising:
a first display for selecting a game of chance, said display having a touch sensitive screen for entering said selection, said first display having a portion for displaying information relating to the play of said selected game of chance; and
a plurality of cameras for capturing a plurality of images relating to the selected game of chance.

34. The gaming machine of claim 33 wherein said gaming machine further comprises a camera focused to capture images of said player.

35. The gaming machine of claim 34 wherein said gaming machine further comprises:
a transmitter module associated with said player; and
a detector circuit for detecting said transmitter module.

36. The gaming machine of claim 33 wherein said first display is an aerial projection display.

37. The gaming machine of claim 33 further comprising:
a second game machine, physically remote from said game machine, having a first display for displaying the play of a game of chance;
a second display for displaying a selected one of said plurality of images; and
means, associated with said second game machine, for selecting one of a plurality of games of chance.

38. The gaming machine of claim 37 wherein said second game machine comprises means for generating an aerial projection display for displaying aerial images relating to the selected game of chance.
